(19) United States
(12) Patent Application Publication
(10) Pub. No.: US 2026/0336337 A1
(43) Pub. Date: Oct. 29, 2026

(54) GOOSENECK HITCH COUPLING SYSTEM FOR TRUCK CAMPERS

(71) Applicant: NB4 Brand L.L.C., d/b/a The Kingstar Company, Chassell, MI (US)

(72) Inventors: Marcus Niemela, Houghton, MI (US); Carson Madsen, Chassell, MI (US)

(21) Appl. No.: 19/661,172

(22) Filed: Apr. 28, 2026

Related U.S. Application Data
(60) Provisional application No. 63/797,082, filed on Apr. 29, 2025.

(51) Int. Cl. B60D 1/06; B60D 1/48; B60P 3/36

(52) U.S. Cl. CPC B60D 1/065; B60D 1/488; B60P 3/36

(57) ABSTRACT

A gooseneck ball hitch coupling system facilitates aligning and securing a truck camper in the bed of a pickup truck that is equipped with a gooseneck hitch structure. The coupling system includes a frame and a pair of horizontally spaced-apart hitch-engaging structures that are mountable to a lower region of the truck camper. The hitch-engaging structures can engage and disengage a lower region of the gooseneck hitch structure that projects upwardly from a lower bed panel of the pickup truck, to selectively secure the coupling system and truck camper to the gooseneck hitch structure. Optionally, the hitch-engaging structures move from an open hitch-receiving configuration to a close hitch-capturing configuration in response to downward movement of the truck camper and coupling system relative to the truck bed, or in response to an actuator.

### CROSS REFERENCE TO RELATED APPLICATION

The present application claims the benefit of U.S. provisional application Ser. No. 63/797,082 filed Apr. 29, 2025, which is hereby incorporated herein by reference in its entirety.

### FIELD

The present disclosure relates to truck campers that are securable and removable from the beds of pickup trucks, and to ball hitches fixed to the bed of pickup trucks and known as “gooseneck” hitches.

### BACKGROUND

Gooseneck hitches are ball hitches mounted at a middle region of a tow vehicle's truck bed and provided for coupling to a trailer for hauling. Gooseneck hitches are typically suited for hauling heavier loads than rear frame-mounted hitches that are positioned behind a rear axle of the tow vehicle.

Truck campers are portable living spaces designed for mounting at the bed of a pickup truck having a bed between left and right sidewalls and a rear liftgate, the rear liftgate typically being removed when the bed is to be fitted with a truck camper. Truck campers typically have narrower lower portions and wider upper portions, which allows for a larger overall living space having a lower portion that fits between the sidewalls on either side of the truck bed, and the wider upper portion extending laterally over the sidewalls, and sometimes laterally beyond them. When truck campers are not mounted at the bed of a truck, they are typically supported above a ground surface for storage, such as by extendable and retractable jacks. To install the truck camper, the user will back their truck toward the forward end of the elevated truck camper while making efforts to align the truck bed with the truck camper. Once aligned, the truck camper is lowered onto the bed of the pickup truck and then secured to the truck by straps, chains, cables, or the like, which connect to tie down points on the side of the truck camper and at the underside of the truck.

### SUMMARY

The present disclosure provides a coupling system that allows a user to install and secure a truck camper within the bed of a pickup truck equipped with a gooseneck hitch by coupling the truck camper to the gooseneck hitch of the pickup truck. This can be accomplished in different ways by “capturing” the ball of the gooseneck hitch with a single structure in response to longitudinal movement of the truck camper and/or associated structure, or with multiple structures that close around the ball in response to longitudinal or vertical movement of the truck camper relative to the ball.

According to one form, a ball hitch coupling system is provided for securing a truck camper in the bed of a pickup truck equipped with a gooseneck hitch structure (e.g., a hitch ball) projecting upwardly from a lower bed panel of the pickup truck. The coupling system includes a frame and a pair of horizontally spaced-apart hitch-engaging structures coupled to the frame, which can be coupled to a lower region of the truck camper. The hitch-engaging structures can selectively provide a wide hitch-receiving space for receiving and releasing the gooseneck hitch structure, and a narrow hitch-engaging space for securing the hitch-engaging structures to the gooseneck hitch structure. The hitch-engaging structures can engage and disengage the gooseneck hitch structure to selectively secure the coupling system and the truck camper to the gooseneck hitch structure.

In one aspect, the hitch-engaging structures include a pair of jaws having proximal end portions that are pivotably coupled to the frame, and distal end portions that are selectively movable away from one another to define the wide hitch-receiving space. The hitch-engaging structures are also movable toward one another to define the narrow hitch-engaging space.

In another aspect, the proximal end portions of the jaws are pivotably coupled to an opposing portion of the frame.

In yet another aspect, the coupling system further includes a retainer system having a retainer link, a retainer plate, and a fastener. The retainer link extends upwardly from each of the jaws, while the retainer plate is configured to receive upper ends of the retainer links. The fastener secures the retainer plate to the retainer links and is configured to lie atop a surface of the lower region of the truck camper. The retainer links pass through an opening formed in the lower region of the truck camper when the jaws are moved toward one another to define the narrow hitch-engaging space. The fastener and the retainer plate cooperate to retain the jaws in position to define the narrow hitch-engaging space, so that the coupling system is secured to the gooseneck hitch structure.

Optionally, a pair of threaded nuts form the fastener and the retainer links include threaded upper end portions for engaging the threaded nuts. The retainer plate defines a pair of holes for receiving the respective retainer links.

In still another aspect, the jaws are biased by gravity to move away from one another and define the wide hitch-receiving space when they are not acted upon by other forces.

In yet another aspect, the coupling system includes a pair of actuating arms having inboard end portions coupled to the jaws, outboard end portions for engaging the lower bed panel of the pickup truck, and respective arm pivots for coupling the actuating arms to the frame. Each the arm pivot is positioned in between the inboard end portion and the outboard end portion of the respective actuating arm. Engagement of the outboard end portions with the bed of the pickup truck causes the inboard end portions to lower and move respective ones of the jaws toward one another.

Optionally, the outboard end portions of the actuating arms include counterweights for biasing the inboard end portions of the actuating arms upwardly to move the respective jaws away from one another in response to the outboard end portions disengaging the lower bed panel of the pickup truck as the truck camper is raised away from the lower bed panel.

In a still further aspect, the outboard end portions of the actuating arms include rollers for engaging the lower bed panel of the pickup truck.

In yet another aspect, the hitch-engaging structures include a pair of tapered walls forming a retainer ramp, the wide hitch-receiving space includes a wide mouth opening defined between the tapered walls at an insertion end of the retainer ramp, and the narrow hitch-engaging space is formed by a narrow channel defined between the tapered walls at a retaining end of the retainer ramp.

In a still further aspect, the tapered walls define a ramped surface having a lower elevation at the wide mouth opening and a higher elevation at the narrow channel. The retainer ramp is configured to urge the truck camper downwardly as the retainer ramp is moved forwardly along the lower bed panel of the pickup truck while the tapered walls engage the gooseneck hitch structure.

According to another form, a ball hitch coupling system is provided for securing a truck camper in the bed of a pickup truck equipped with a gooseneck hitch structure projecting upwardly from a lower bed panel of the pickup truck. The coupling system includes a pair of tapered walls forming a retainer ramp that has an insertion end region defining a wide hitch-receiving space, and a retaining end region defining a narrow hitch-engaging channel. The tapered walls further define a ramped surface having a lower elevation at the wide hitch-receiving space and a higher elevation at the narrow hitch-engaging channel. The retainer ramp is configured to urge the truck camper downwardly as the retainer ramp is moved forwardly along the lower bed panel of the pickup truck while the tapered walls engage the gooseneck hitch structure.

Optionally, the tapered walls cooperate to form a curved V-shape extending from the wide hitch-receiving space to the narrow hitch-engaging channel.

In one aspect, the coupling system further includes a pair of rails supporting the retainer ramp so that the retainer ramp is longitudinally movable relative to the rails and the truck camper. An actuation mechanism is provided for driving the retainer ramp along the rails between an unlocking position in which the wide hitch-receiving space receives the gooseneck hitch structure, and a locking position in which the narrow hitch-engaging channel receives the gooseneck hitch structure. In the locking position the tapered walls engage respective portions of the gooseneck hitch structure to secure the coupling system and the truck camper to the gooseneck hitch structure.

In another aspect, the actuation mechanism includes a powered drive, such as one having a drive motor and at least one extendable and retractable cylinder coupled to the retainer ramp.

Therefore, the gooseneck ball hitch coupling system allows for securement of a truck camper in the bed of a pickup truck without relying on (or without relying entirely on) tie-down cables, straps, chains, or the like, while also ensuring that the truck camper is properly positioned in the truck bed. The coupling system generally includes a pair of horizontally spaced-apart hitch-engaging structures for mounting in an opening formed in a lower region of the truck camper. The hitch-engaging structures can engage and disengage a lower region of the gooseneck hitch structure that projects upwardly from a lower bed panel of the pickup truck, either by moving the entire coupling system and truck camper, or by actuating the coupling system between coupling and uncoupling configurations. In some embodiments the transition from uncoupling to coupling is effected by longitudinal or vertical movement of the truck camper and coupling system into the truck bed. This can greatly simplify the loading and securing process for a truck camper, and in particular can facilitate one-person loading operations.

These and other objects, advantages, purposes and features of this invention will become apparent upon review of the following specification in conjunction with the drawings.

### BRIEF DESCRIPTION OF THE DRAWINGS

FIG. 1 is a front-left perspective view of a truck camper.

FIGS. 2 and 3 are front-left perspective views of the truck camper of FIG. 1 being lowered into the bed of a pickup truck equipped with a gooseneck hitch;

FIG. 4 is a combined top perspective view of a pickup truck equipped with a gooseneck hitch ball, and a bottom perspective view of a truck camper fitted with a one-piece ball coupler;

FIG. 5 is a rear sectional elevation view of the truck and truck camper of FIG. 4, shown fitted together, and taken through a lateral plane that extends through the ball;

FIG. 6 is an enlarged view of the area designated VI in FIG. 5;

FIG. 7 is a top plan view of the bed region of the truck and the bottom portion of the truck camper of FIG. 4, shown fitted together.

FIG. 8 is an enlarged view of the area designated VIII in FIG. 7;

FIG. 9 is a side sectional view of a lower region of the truck and truck camper of FIG. 4, taken along a longitudinal central plane, and with the truck camper and truck shown fitted together;

FIG. 10 is an enlarged view of the area designated X in FIG. 9;

FIG. 11 is a top perspective view of a truck bed and a self-attaching variation of the one-piece ball coupler of FIGS. 4-9;

FIG. 12 is a side perspective view of the self-attaching one-piece ball coupler of FIG. 11;

FIG. 13A is a top plan view of the self-attaching one-piece ball coupler and truck bed of FIG. 11, shown in an unlocked position;

FIG. 13B is another top plan view of the self-attaching one-piece ball coupler and truck bed of FIG. 11, shown in a locked position;

FIG. 14 is a front elevation view of the self-attaching one-piece ball coupler and truck bed of FIG. 11;

FIG. 15 is a bottom perspective view of a truck camper fitted with another ball coupler for vertical or longitudinal engagement with the gooseneck hitch ball;

FIG. 16 is an enlarged view of the area designated XVI in FIG. 15;

FIG. 17 is a side sectional view of a lower region of a truck and the truck camper of FIG. 15, taken along a longitudinal central plane, and with the truck camper shown elevated relative to the bed of a truck with gooseneck hitch ball;

FIG. 18 is an enlarged view of the area designated XVIII in FIG. 17;

FIG. 19 is a side sectional view of a lower region of a truck and the truck camper of FIG. 15, taken along a longitudinal central plane, and with the truck camper shown fully lowered into the truck bed and engaging the gooseneck hitch ball;

FIG. 20 is an enlarged view of the area designated xx in FIG. 19;

FIG. 21 is a top plan view of the bed region of the truck and the bottom portion of the truck camper of FIG. 19;

FIG. 22 is an enlarged view of the area designated XXII in FIG. 21;

FIG. 23 is a rear sectional elevation view of the truck and truck camper of FIG. 19, taken through a lateral plane that extends through the ball;

FIG. 24 is an enlarged view of the area designated XXIV in FIG. 23;

FIG. 25 is a bottom perspective view of a truck camper fitted with another ball coupler for vertical engagement with the gooseneck hitch ball;

FIG. 26 is an enlarged view of the area designated XXVI in FIG. 25;

FIG. 27 is a side sectional view of a lower region of a truck and the truck camper of FIG. 25, taken along a longitudinal plane, and with the truck camper shown mostly lowered into the truck bed and engaging the truck bed ahead of and behind the gooseneck hitch ball;

FIG. 28 is an enlarged view of the area designated XXVIII in FIG. 23;

FIG. 29 is another enlarged view of the area designated XXVIII in FIG. 23, providing a section view through the center of the hitch ball and coupler;

FIG. 30 is a side sectional view of a lower region of a truck and the truck camper of FIG. 25, taken along a longitudinal central plane, and with the truck camper shown fully lowered into the truck bed and engaging the gooseneck hitch ball;

FIG. 31 is an enlarged sectional side elevation view of the area designated XXXI in FIG. 30;

FIG. 32 is a rear sectional elevation view of the truck and truck camper of FIG. 30, taken through a lateral plane that extends through the ball;

FIG. 33 is an enlarged view of the area designated XXXIII in FIG. 32;

FIG. 34 is a top plan view of the bed region of the truck and the bottom portion of the truck camper of FIG. 30;

FIG. 35 is an enlarged view of the area designated XXXV in FIG. 34;

FIG. 36 is another enlarged view of the area designated XXXV in FIG. 34, but taken through a horizontal plane passing through a neck region of the gooseneck hitch ball and corresponding regions of the ball coupler of FIGS. 25-36;

FIG. 37 is a side elevation view of another gooseneck hitch ball coupler shown integrated within the floor space of a truck camper that is lowered onto a truck bed of a truck equipped with a gooseneck hitch; and

FIG. 38 provides, at left, a side elevation view of a rear hitch coupler at a rear end portion of a truck camper mounted in the bed of a truck, with an exploded perspective view shown to the right.

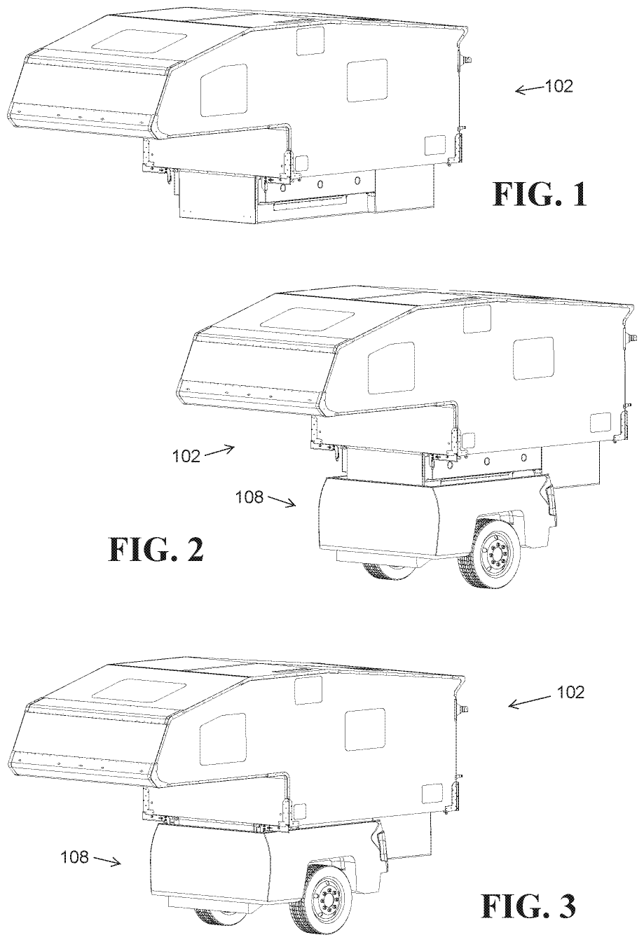

### DESCRIPTION OF THE PREFERRED EMBODIMENTS

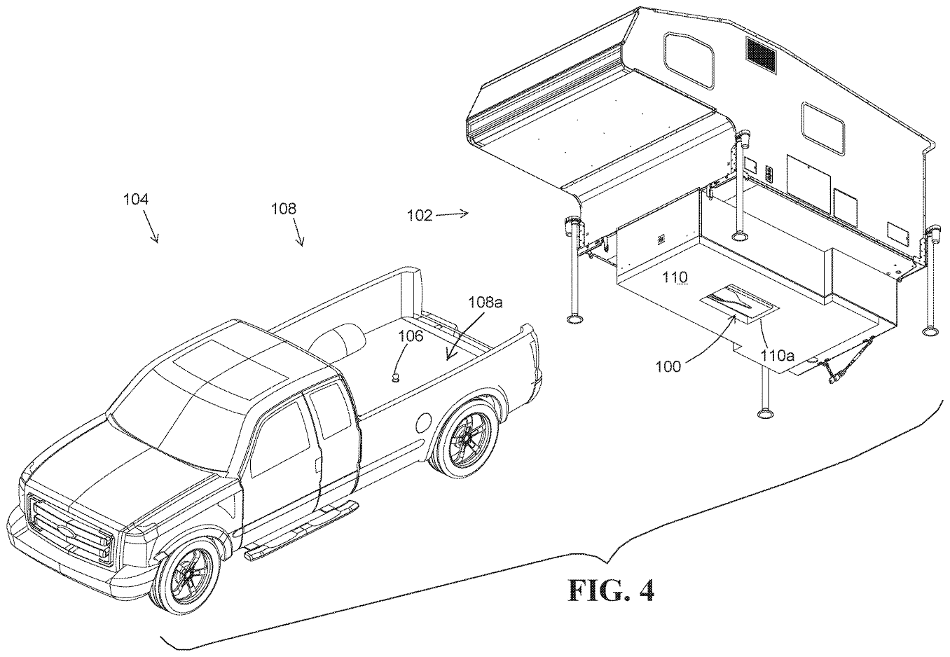

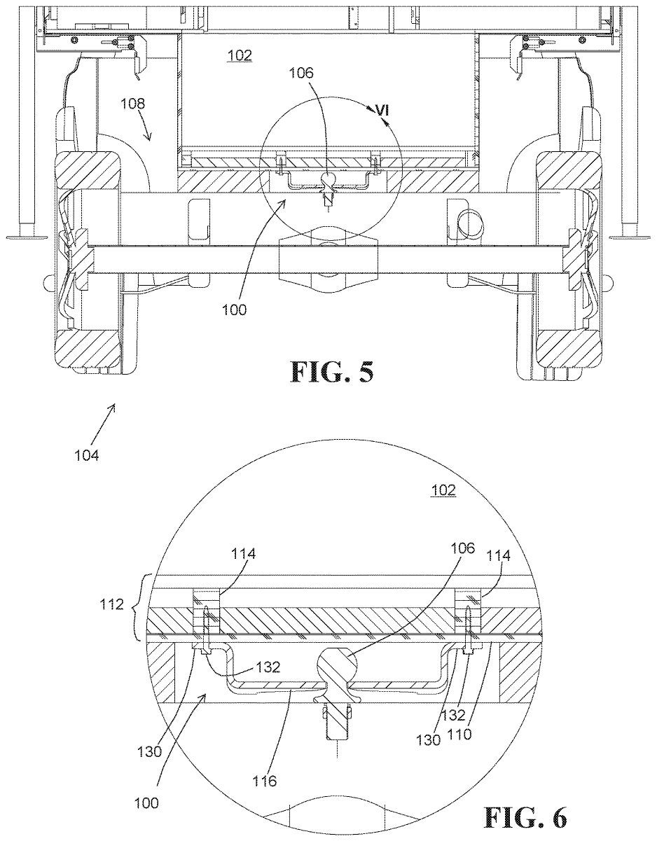

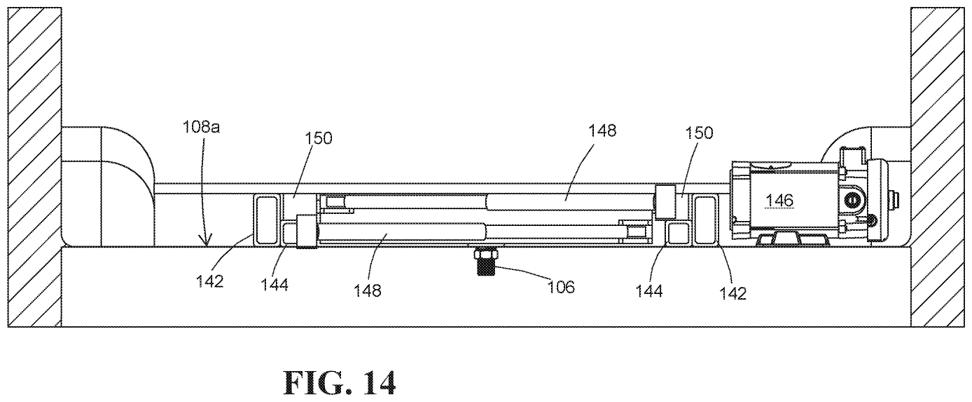

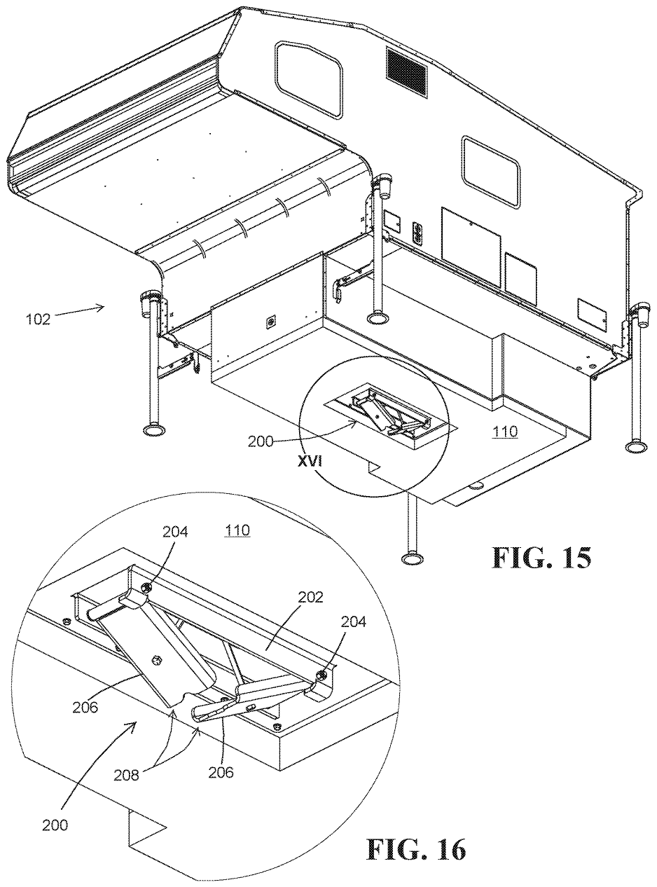

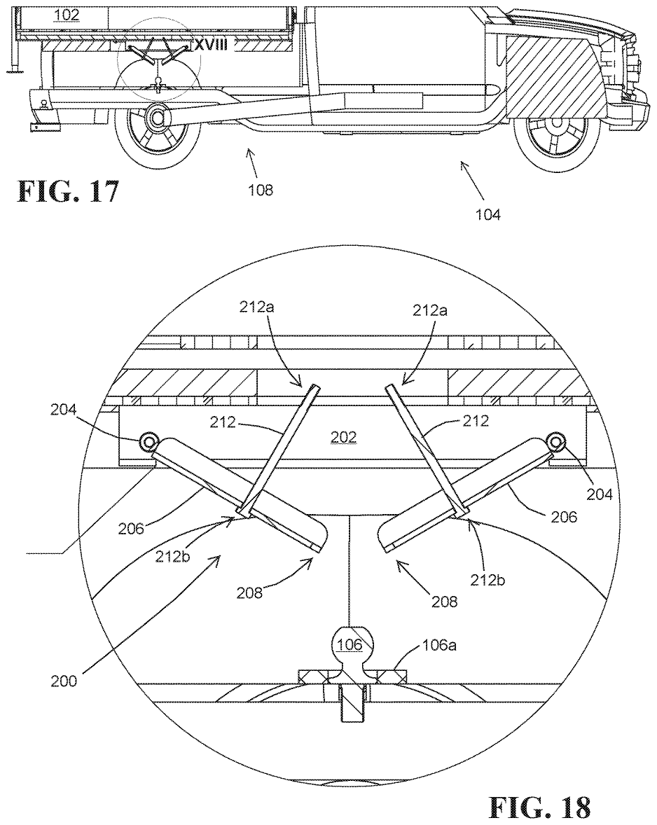

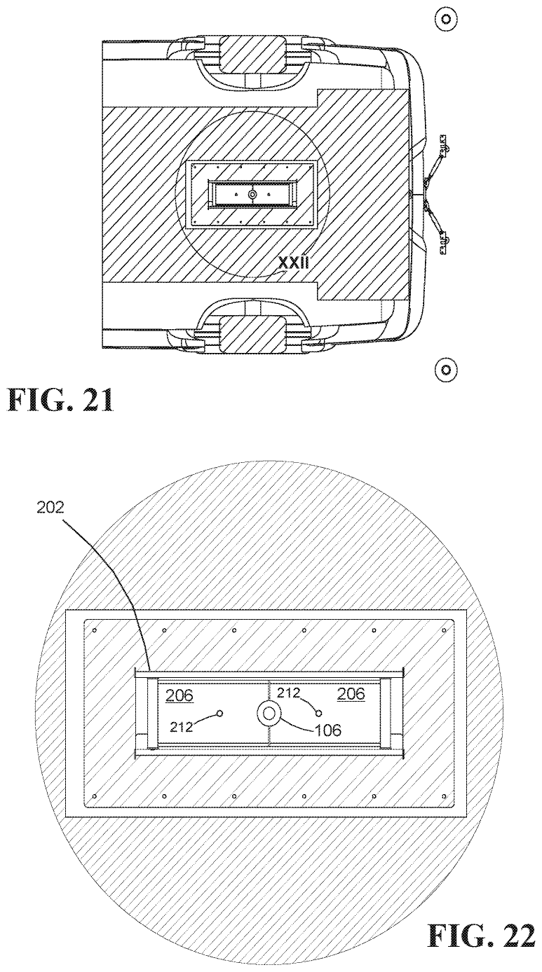

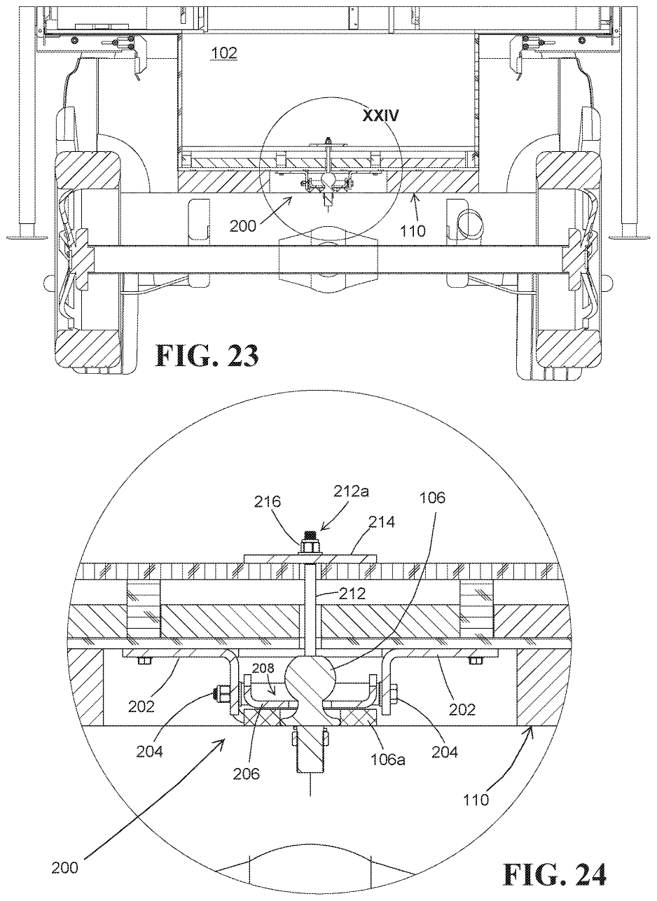

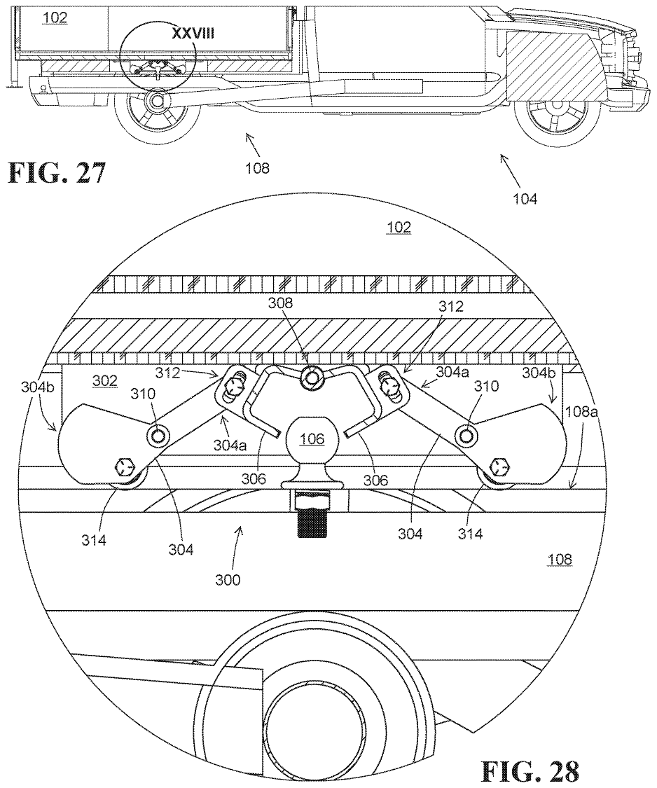

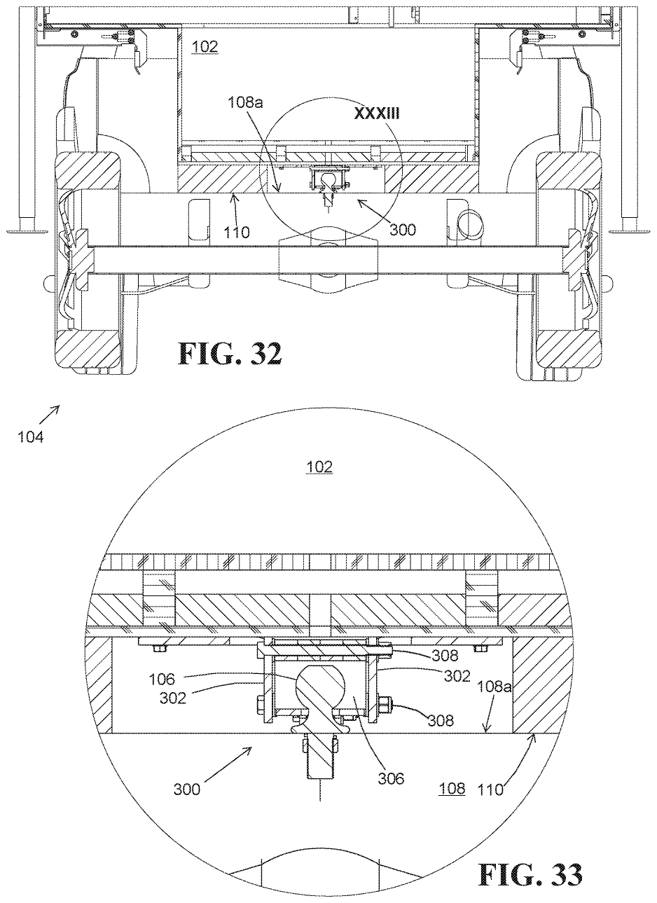

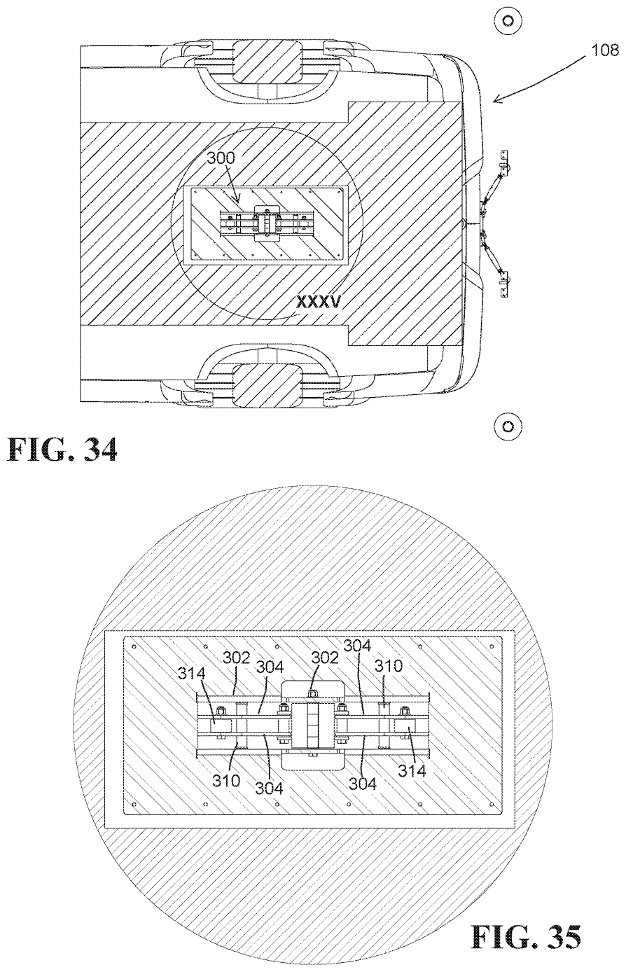

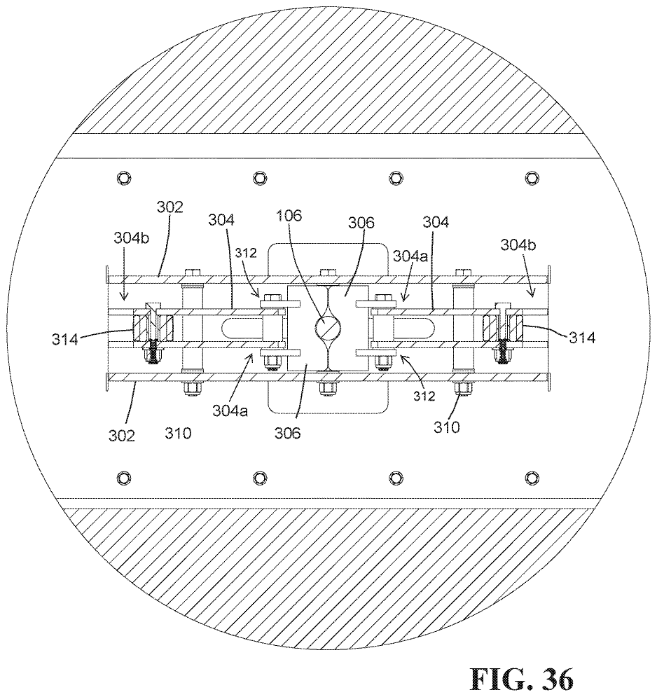

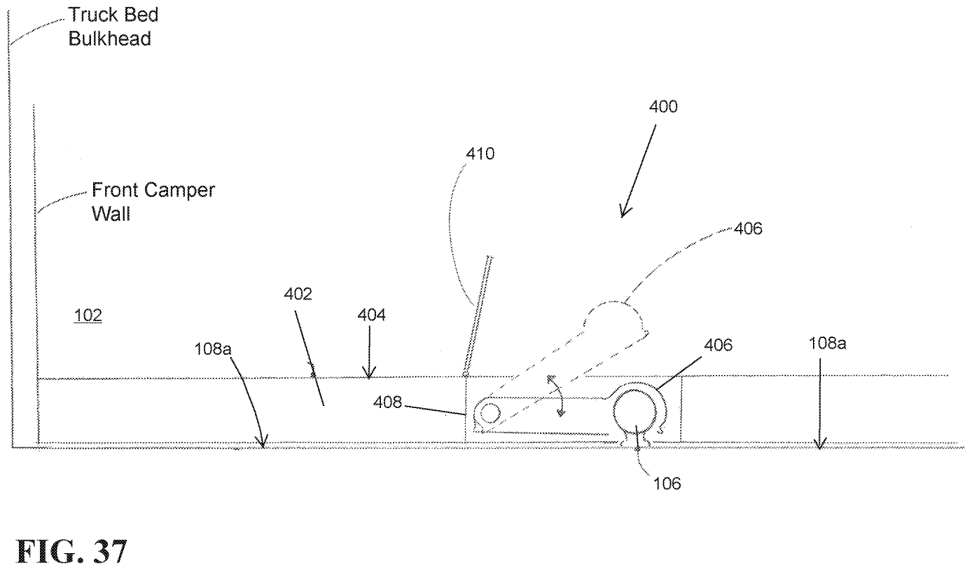

Referring now to the drawings and illustrative embodiments depicted therein, a first gooseneck hitch coupling system 100 (FIGS. 4-10) is coupled to the underside of a truck camper 102 for use in coupling the truck camper 102 onto a truck 104 equipped with a gooseneck hitch ball 106 at the bottom of the truck's bed 108 to simplify coupling the truck camper 102 to the truck 104. The coupling system 100 provides a secure connection between the truck camper 102 and the gooseneck hitch ball 106 while simplifying alignment, and may facilitate the coupling process as a one-person operation. Various other coupling systems are disclosed, including those that selectively extend from the bottom panel 110 of the truck camper 102, as with the embodiments shown in FIGS. 15-24 and FIGS. 25-36, or those that are integrated within the floor space 112 of the truck camper 102 (see FIG. 6), as with the embodiments shown in FIGS. 4-14 and in FIG. 37. When the truck camper 102 is equipped with one of the coupling systems disclosed herein, a user may install the truck camper 102 into the truck bed, aligned to the gooseneck hitch ball 106, either by lowering the truck camper 102 into the truck bed 38 using jack stands or a hoist, or by backing the truck 104 longitudinally relative to the truck camper 102 so that the lower region of the truck camper 102 is received in the truck bed. In some embodiments, the coupling system self-couples with the gooseneck hitch ball 106 upon positioning of the truck camper 102.

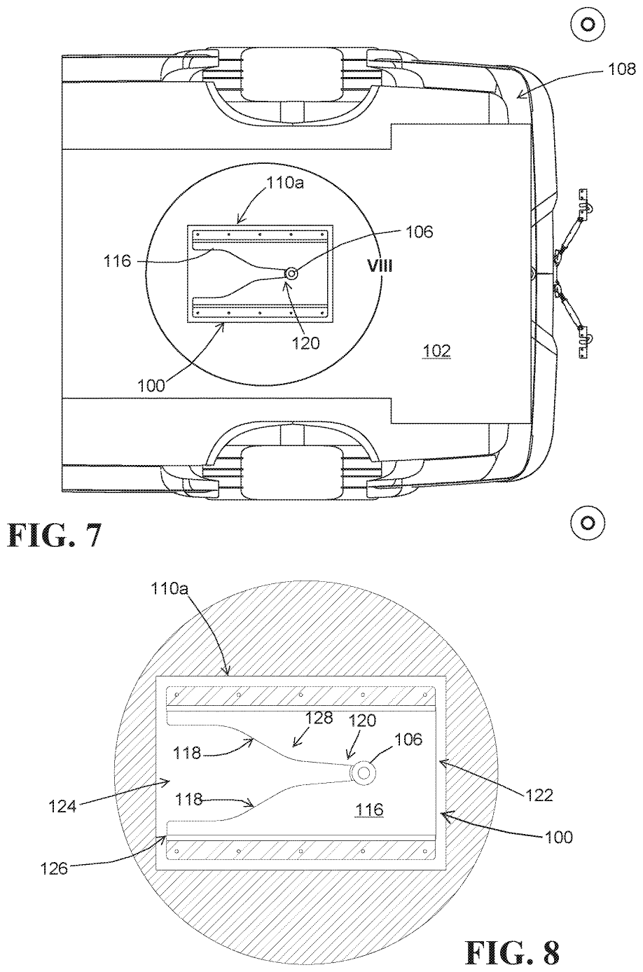

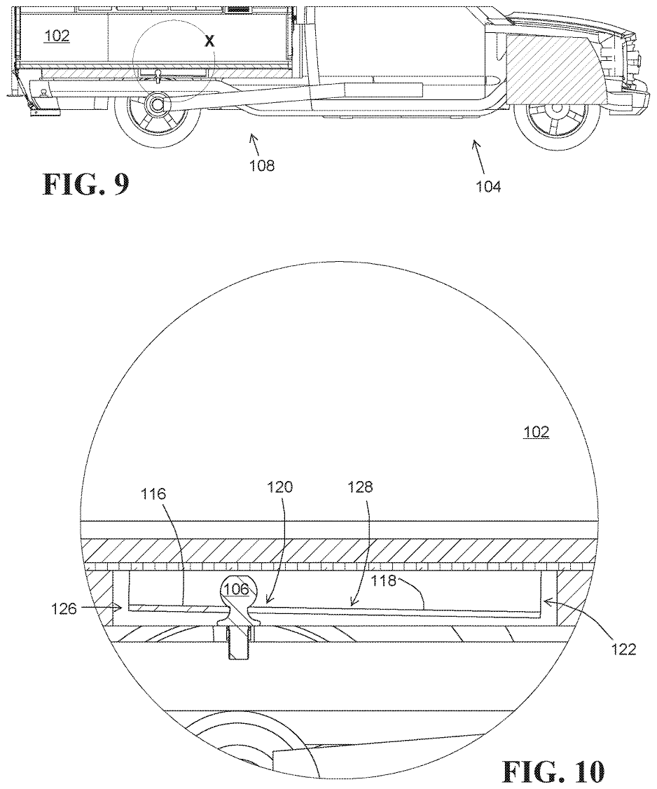

In the embodiment of FIGS. 4-10, and in particular FIG. 6, a frame 114 is mounted within the floor space 112 of the truck camper and proximate the bottom panel 110 of the truck camper 102. The frame 114 provides a solid structure for mounting a retainer ramp 116 that is disposed in a rectangular opening 110a in the bottom of truck camper 102 (FIGS. 4 and 7). The retainer ramp 116 includes a pair of horizontally spaced-apart hitch-engaging structures in the form of tapered walls 118 that wedge against the bottom of the gooseneck hitch ball 106 as the truck camper 102 moves forward in the truck bed 108, as can be envisioned with reference to FIGS. 9 and 10, while the curved V-shape of the tapered walls 118 in the overhead views (FIGS. 7 and 8) causes the truck camper 102 to center laterally on the gooseneck hitch ball 106 during the same movement. Thus, when a user installs the truck camper 102 using the embodiment of FIGS. 4-10, the retainer ramp 116 aids the user in alignment of the truck camper 102 and also secures the truck camper 102 to the gooseneck hitch ball 106 by guiding and lodging the gooseneck hitch ball 106 into a narrow channel 120 at a retaining end 122 of the retainer ramp 116, and prevents the truck camper 102 from moving too far forward in the truck bed 108 and undesirably contacting the truck's cab. To aid the user in alignment of the truck camper 102 as it is installed, a wide mouth opening 124 formed at an insertion end 126 of the retainer ramp 116 initially receives the gooseneck hitch ball 106. As best shown in FIG. 8, the wide mouth 124 gives way to narrowing toward the retaining end 122, forming a narrowing channel 128 between them. If the user inserts the gooseneck hitch ball 106 at a peripheral point of the wide mouth 124 rather than at its center, as the gooseneck hitch ball 106 is further inserted the narrowing channel 128 forces the coupling system 100 and truck camper 102 to shift and align with the gooseneck hitch ball 106, which is centered in the truck bed 108.

The retainer ramp 116 may be formed of any number of pieces that together or alone create a functional shape like the embodiment shown in FIGS. 4-10. In the illustrated embodiment, the retainer ramp 116 has upper brackets 130 that receive threaded bolts 132 extending upwardly through the truck camper's bottom panel 110 and into the frame 114 as shown in FIG. 6. As best shown in FIG. 10, the tapered walls 118 also slope upwardly toward the gooseneck hitch ball 106 in the direction of insertion. This slope causes the gooseneck hitch ball 106 to be lodged between the tapered walls 118, at the narrow channel 120 between the tapered walls 118.

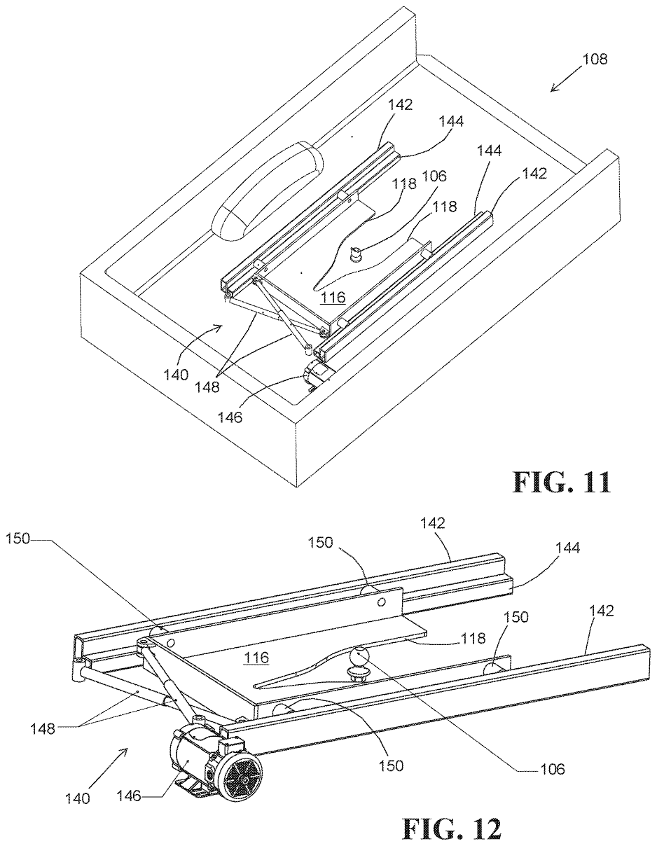

Optionally, the retainer ramp 116 of first gooseneck hitch coupling system 100 can be incorporated into a powered actuation mechanism 140, as shown in FIGS. 11-14. In the illustrated embodiment, powered actuation mechanism 140 includes a pair of outboard frame rails 142, a pair of inboard frame rails 144 that are mounted along lower inboard surfaces of the outboard frame rails 142 to form rolling tracks, a hydraulic motor and pump 146, a pair of extendable and retractable cylinders 148, and rollers 150 extending laterally outwardly from opposite sides of the retainer ramp 116. Rollers 150 roll along the inboard frame rails 144 as the retainer ramp 116 is pushed and pulled by the extendable and retractable cylinders 148. Cylinders 148 are arranged in an X shape crossing one another, with opposing ends coupled to a forward end of the retainer ramp 116 and to forward ends of the respective inboard frame rails 144. When the cylinders 148 are retracted the retainer ramp 116 slides or rolls forwardly relative to the frame rails 142, 144 (which are fixed to the truck camper 102), causing the retainer ramp 116 to disengage the ball 106 if the truck camper 102 has been installed in the truck bed 108. When the cylinders 148 are extended the retainer ramp 116 slides or rolls rearwardly relative to the frame rails 142, 144, causing the retainer ramp 116 to engage the ball 106 and center the truck camper 102 if the truck camper is being installed in the truck bed 108. This action may also draw the truck camper 102 fully forward in the truck bed 108 if the truck camper 102 is not already positioned longitudinally fully forward during initial lowering of the truck camper 102 into the truck bed 108.

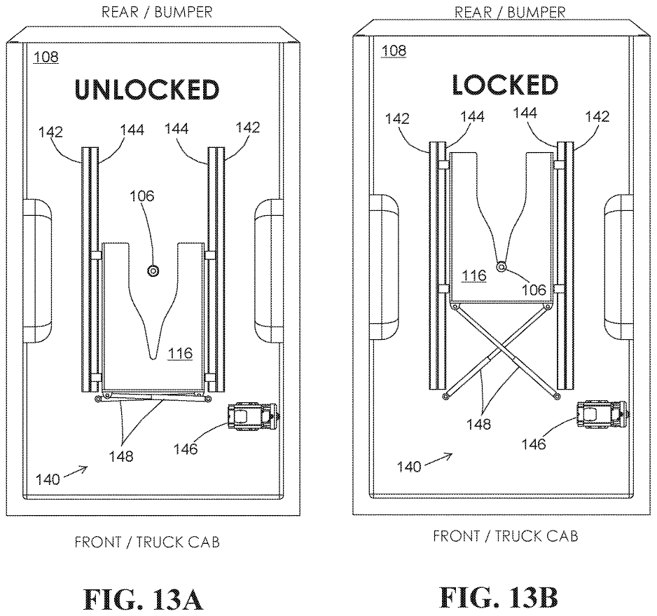

Powered actuation mechanism 140 thus allows a user to lower the truck camper 102 vertically into the bed 108, or to drive the truck 102 in reverse with the truck camper 102 and retainer ramp 116 elevated above the ball 106. The truck camper 102 can then be lowered so that the ball 106 extends upwardly into the wide mouth 124 or narrowing channel 128 between the tapered walls 118 (FIGS. 11-13A). At this point the hydraulic motor and pump 146 can be activated to extend the extendable and retractable cylinders 148 and cause the retainer ramp 116 to roll or slide rearwardly, engaging the ball 106 and securing the truck camper 102 as described above, and as shown in FIG. 13B. Numerous variations are envisioned, such as manual or powered screw-drive actuation of the retainer ramp 116, electrically or pneumatically extendable and retractable cylinders, and the like.

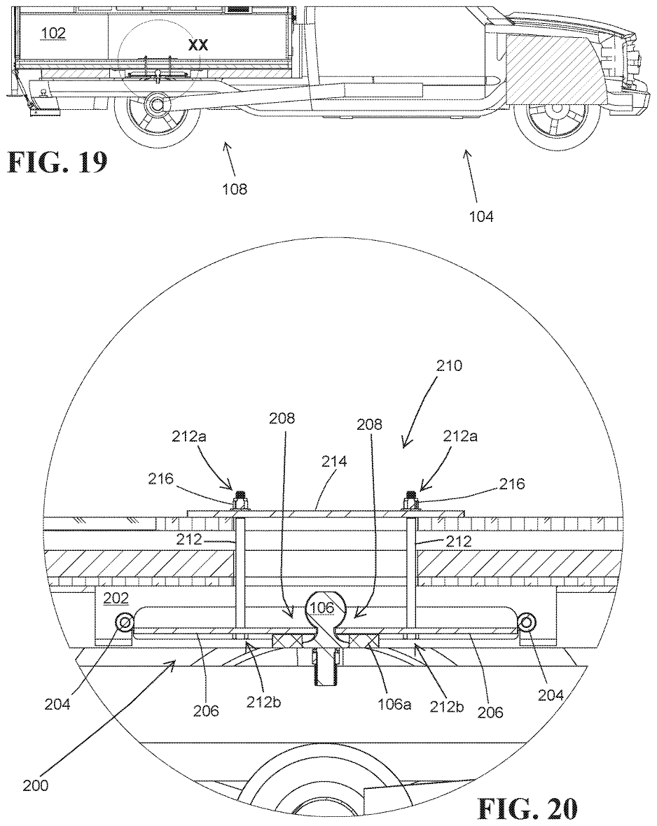

Referring now to FIGS. 15-24, another coupling system 200 operates pivotably between an open configuration (FIGS. 15-18) and a closed configuration (FIGS. 19-24). A frame 202 is mounted to the bottom of the truck camper 102 and provides respective pivotal mounting points 204 for two horizontally spaced-apart hitch-engaging structures in the form of capturing arms or jaws 206. Each capturing arm or jaw 206 is pivotally mounted to the frame 202 at one end (pivotal mounting point 204) and extends to an opposed capturing end 208 which (in the open configuration) extends lower than the rest of the coupling system 200 (FIG. 18) so that it can be lowered below the gooseneck hitch ball 106 (FIG. 20). The capturing ends 208 are lowered down along opposite sides or ends of the gooseneck hitch ball 106 when the truck camper is lowered into the truck bed 108 (compare FIG. 20 to FIG. 18). It will be appreciated that the shape of a base 106a of a gooseneck hitch ball 106 may vary, and that as the truck camper is lowered onto the truck bed 108, the capturing ends 208 of the capturing arms 206 may first contact a bottom panel of the truck bed 108 or the gooseneck hitch base 106a depending on the shape of the base 106a.

It will further be appreciated that the coupling system 200 allows for the truck 104 to be backed up to receive the truck camper 102, rather than lowering the camper 102 into the bed 108. In this method, the forward capturing arm 206 engages the ball 106 and pivots up as the truck bed 108 receives the camper 102 in the longitudinal direction. When the forward capturing arm's capturing end 208 passes over the ball 106, the forward capturing arm 206 drops so that its capturing end is directly in front of the ball 106, which is now located between the two capturing ends 208. If the user were to continue moving the truck 104 rearwardly, the ball 106 would contact the capturing end 208 of the rearward capturing arm 206 and prevent the forward end of the camper 102 from moving too far forward relative to the bed 108 and the truck's cab. If further lowering of the camper 102 is needed for it to be entirely supported in the bed 108, this can now be done and the capturing arms 206 will close around a neck region of the ball 106 as shown in FIG. 20.

The coupling system 200 of FIGS. 15-24 further includes a retainer system 210 which has an unsecured configuration (FIGS. 15-18) in which capturing arms 206 are free to pivot about their respective pivotal mounting point 204, and a secured configuration (FIGS. 19, 20, 23, and 24) in which capturing arms 206 are prevented from being lowered relative to the camper 102. The coupling system 200 of FIGS. 15-24 is gravitationally biased to the open configuration of FIGS. 15-18, and optionally may be spring-biased toward the open configuration. In its secured configuration of FIGS. 19, 20, 23, and 24, the coupling system 200 is secured to the gooseneck hitch ball 106 by securing the capturing arms 206 in their closed configurations with the capturing ends 208 seated around the neck of the ball 106 as shown in FIGS. 19-24. This is accomplished by retainer links 212 that are each formed with an upper threaded end portion 212a and an opposite lower end portion 212b that couples to the respective capturing arm 206 (FIGS. 18 and 20). In the closed configuration as illustrated in FIG. 20, the retainer links 212 extend vertically from the capturing arms 206, passing through a slot or opening formed in the truck camper bottom.

The lower ends 212b of the retainer links 212 are attached to the capturing arms 206 so that when the capturing arms 206 pivot into the closed (raised) configuration in response to lowering the truck camper 102, the upper threaded ends 212a of the retainer links 212 pass through holes or a slot in the truck camper floor and are positioned for locking of the retainer system 210, shown in FIG. 20. The user then secures the retainer system 210 from within the truck camper 102, where the upper threaded ends 212a of the retainer links 212 become accessible when the coupling system 200 is closed (FIG. 20). To lock the retainer system 210, a retainer plate 214 having respective holes for receiving the upper threaded ends 212a is placed over the ends 212a and a portion of the camper's floor structure, and then retainer nuts 216 or other securing devices are fastened onto the upper threaded ends 212a of the retainer links 212, above the retainer plate 214. This fastening locks the retainer system 210 by securing the threaded ends 212a of the retainer links 212 to the retainer plate 214.

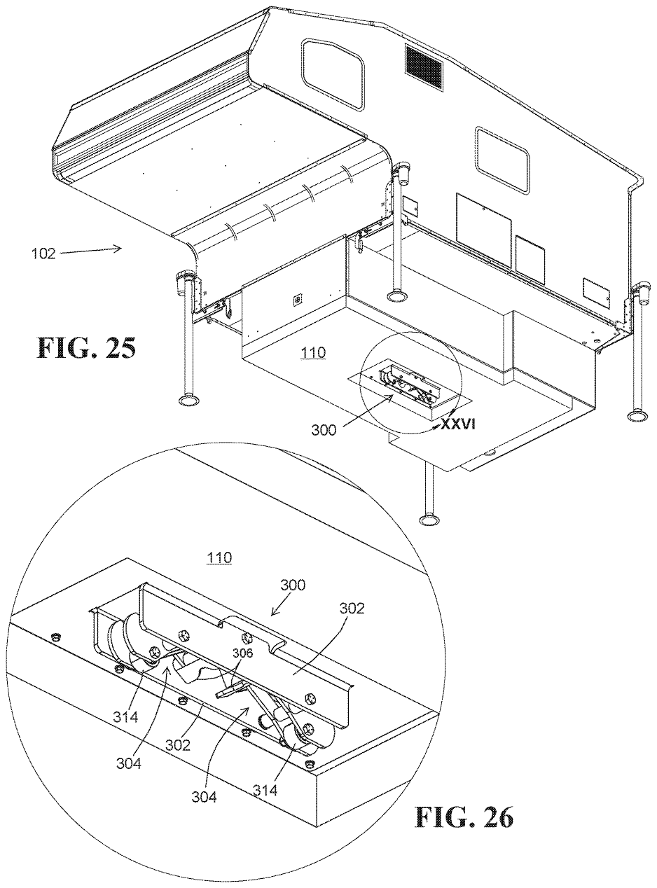

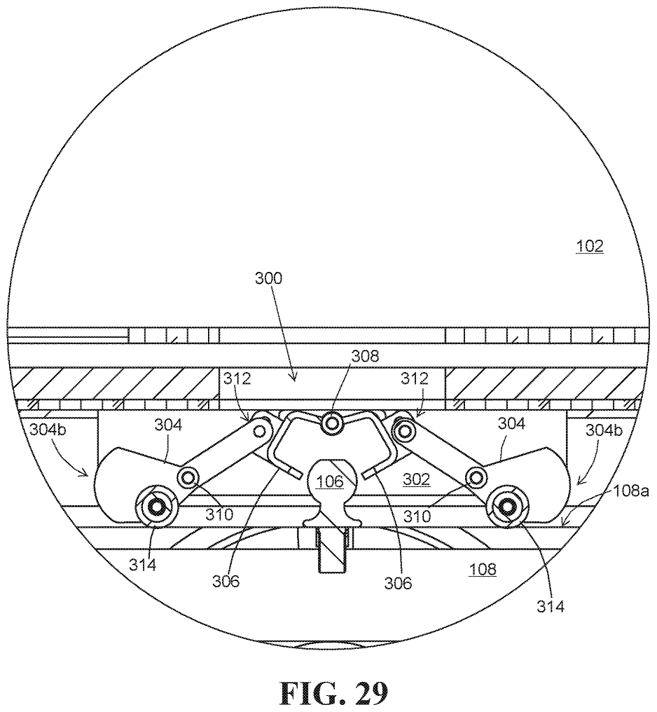

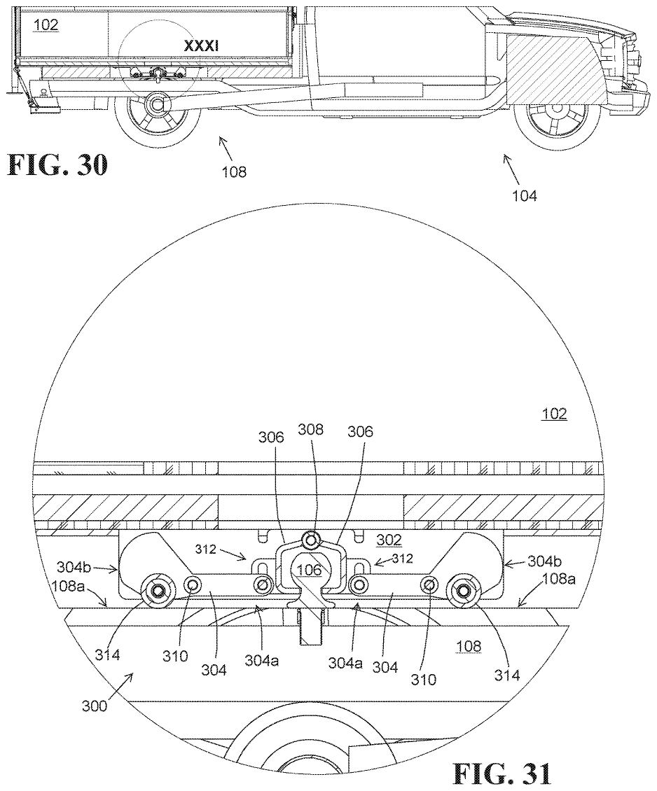

Referring now to FIGS. 25-36, a third embodiment coupling system 300 also rotationally operates between an open configuration (FIGS. 25-29) and a closed configuration (FIGS. 30-36), and can automatically close around the gooseneck hitch ball 106 in response to lowering the truck camper into the truck bed. A frame 302 is mounted to the bottom of the truck camper 102 and structurally supports a pair of actuating arms 304 that are pivotally-mounted to the frame 302, as are a pair of horizontally spaced-apart hitch-engaging structures in the form of pivotally-mounted jaws 306 sharing a common pivot point 308 directly above the hitch ball 106 when the camper 102 is centered in truck bed 108. Each capturing arm 304 is an angular body that is pivotally mounted to frame 302 at a respective arm pivot 310, with an inboard end portion 304a that engages a respective slot-coupling 312 associated with each respective jaw 306. Opposite the inboard end portions 304a are outboard end portions 304b that serve as counterweights, and may incorporate counterweight components, to bias inboard end portions 304a upwardly. Each outboard end portion 304b is fitted with a roller 314 that engages the upper bed surface 108a of the truck bed 108 as camper 102 is lowered, such as shown in FIG. 31. To capture the gooseneck hitch ball 106, the actuating arms 304 begin with the inboard end portions 304a in a raised state (FIG. 29) due to the counterweight of outboard end portions 304b, and the arms 304 hold the jaws 306 in their open configuration. The jaws 306 remain open until rollers 314 contact the upper bed surface 108a and begin rising upwardly relative to the camper 102, causing the actuating arms' inboard end portions 304a to lower and close jaws 306 around ball 106 (FIG. 31). A manual or power-actuated locking mechanism may be provided between jaws 306 and/or actuating arms 314 and/or frame 302 so that ball 106 cannot be inadvertently pulled out from between the jaws 306, such as in response to the truck 104 encountering a substantial bump while driving.

Thus, actuating arms 304 automatically close the coupling system 300 to capture ball 106 as the truck camper 102 lowers into the truck bed 108. As the truck camper 102 is fully lowered into the truck bed 108 the rollers 314 move longitudinally away from one another across the truck bed's upper surface 108a and rotationally transmit force from the truck bed surface 108a to the inboard end portions 314a. This causes the inboard end portions 314a to draw the jaws 306 down toward the gooseneck hitch ball 106. Re-opening of the coupling system 300 occurs when the truck camper is lifted from the truck bed 108 when any locking mechanism is disengaged, and may be caused by gravity acting on the actuating arms 304, which are asymmetrically weighted as described above. Optionally, re-opening may be caused or aided by torsion springs located at the arm pivots 310.

Referring now to FIG. 37, a fourth embodiment coupling system 400 includes a frame 402 mounted within the floor space of a truck camper 102, above a hole in the truck camper bottom 404. Frame 402 provides a rigid structure upon which a ball hitch coupler 406 is pivotally coupled 408. A hitch access panel 410 sits above the ball hitch coupler 406 and opens for the user to access the ball hitch coupler 406 or closes to conceal the ball hitch coupler 406 and to align with the truck camper floor 404. The user operates the ball hitch coupler 406, which pivots to open or close over the gooseneck hitch ball 106, from the inside of the truck camper 102 after the truck camper 102 has been positioned onto the truck bed 108 and after the hitch access panel 410 has been opened. The ball hitch coupler 406 retains the gooseneck hitch ball 106 by encapsulating the gooseneck hitch ball 106 with its rigid structure, such as in the manner of a traditional ball hitch coupler for a trailer.

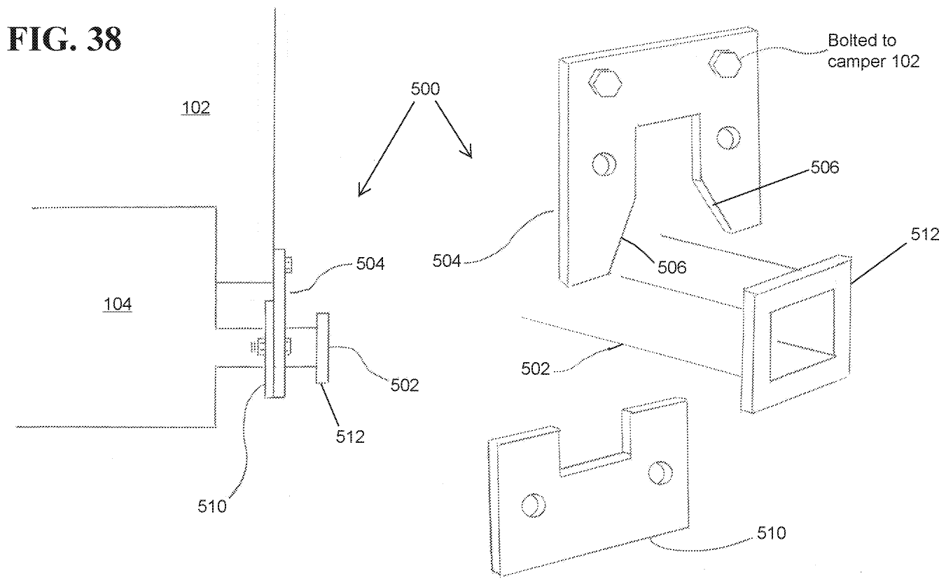

Any of the coupling systems 100, 200, 300, 400 described above may be supplemented with a truck camper retainer 500 such as shown in FIG. 38. The truck camper retainer 500 connects the rear of the truck camper 102 to the square-tubular body of a rear hitch receiver 502 at the rear of a truck, and provides a second secure mounting point for the truck camper that helps to ensure the truck camper will not pitch forwardly or rearwardly about a lateral axis extending through the gooseneck hitch ball 106, provides additional securement for the truck camper 102 to the truck 104 during movement operations, and helps to ensure that the truck camper 102 does not yaw about a vertical axis or tilt about a longitudinal axis. Truck camper retainer 500 may be equipped onto the truck camper 102 alone or in combination with traditional cables or chains, or any one of the four coupling systems 100, 200, 300, 400 described above.

When coupled onto a truck camper 102 that is fully installed onto the truck 104, the truck camper retainer 500 retains the truck camper 102 by preventing vertical movement of the truck camper's rear end, and by preventing horizontal movement of the truck camper 102 beyond a predetermined position. In the preferred embodiment, a primary guide plate 504 couples the truck camper retainer 500 to the rear of a truck camper 102 through a bolted connection. Slanted inner surfaces 506 of the primary guide plate 504 interface with the surface of the hitch receiver 502 to aid the user in alignment of the truck camper 102 as the truck camper 102 is lowered into the truck bed 108 and onto the truck bed's upper surface 108a.

When the truck camper has been fully lowered onto the truck bed upper surface 108a and the primary guide plate 504 has been coupled onto the truck camper 102, the user couples a secondary guide plate 510 onto the primary guide plate 504 to fully install the truck camper retainer 500. The primary guide plate 504 and secondary guide plate 510, when coupled together, form a secure connection between the truck camper 102 and the hitch receiver 502, which may allow the truck camper 102 to slide or shift a limited distance forward or rearward in a longitudinal direction within the truck bed 108. However, any rearward movement is limited by a flange 512 at the end of the hitch receiver 502. The flange 512 acts as a backstop that cannot pass between the primary 504 and secondary 510 guide plates.

Thus, the gooseneck ball hitch coupling systems disclosed herein provide for secure and simplified alignment and coupling of a truck camper to the bed of a truck that is equipped with a gooseneck ball hitch or similar towing structure. Such coupling helps to ensure that the truck camper is aligned laterally (side-to-side) and longitudinally (forward-backward) in the bed of the truck, in addition to being held secure in the bed of the truck, optionally without the use of chains, straps, or cables along the exterior sides of the truck camper and truck. This can reduce the time needed for installing and securing the truck camper in the bed of a truck equipped with a gooseneck hitch or similar structure, as well as for removing the truck camper from the truck. It will be appreciated that the location of the ball hitch coupling system may be adjusted along the bottom of a given truck camper for the desired truck's bed and location of its gooseneck hitch ball. Optionally, the gooseneck ball hitch coupling systems may be used in conjunction with other loading and alignment aids, such as the guide and support brackets that are described in commonly-owned U.S. patent application, Ser. No. 19/211,793, filed May 19, 2025, which corresponds to U.S. Pub. No. 2025/0353425.

Once the coupling system's location is set where desired along the truck camper's lower region, the truck camper may be reliably installed and reinstalled in the same truck bed in a consistent and repeatable manner, consistently achieving a desired longitudinal spacing from the forward end of the truck's bed and/or the rear of the truck's cab, as well as desired lateral centering and spacing from the left and right interior sides of the truck's bed. If the truck camper is to be mounted in a different truck with a differently-dimensioned bed and/or a differently-positioned gooseneck hitch ball, it may be possible to change the location of the gooseneck ball hitch coupling system while the truck camper is out of the truck bed, by loosening fasteners of the coupling system, sliding the coupling system fore or aft, and tightening the fasteners. Simple measurements of the distance between the gooseneck hitch ball and the forward end of the truck bed or rearward end of the truck cab may be sufficient to achieve a desirable position of the gooseneck ball hitch coupling system without need for trial-and-error.

Changes and modifications in the specifically described embodiments can be carried out without departing from the principles of the present invention which is intended to be limited only by the scope of the appended claims, as interpreted according to the principles of patent law including the doctrine of equivalents.

1. A ball hitch coupling system for securing a truck camper in the bed of a pickup truck equipped with a gooseneck hitch structure projecting upwardly from a lower bed panel of the pickup truck, said coupling system comprising:
a frame configured for coupling to a lower region of the truck camper;
a pair of horizontally spaced-apart hitch-engaging structures coupled to said frame;
wherein said hitch-engaging structures are configured to selectively provide a wide hitch-receiving space configured for receiving and releasing the gooseneck hitch structure, and a narrow hitch-engaging space for securing said hitch-engaging structures to the gooseneck hitch structure; and
wherein said hitch-engaging structures are configured to selectively engage and disengage the gooseneck hitch structure, to selectively secure said coupling system and the truck camper to the gooseneck hitch structure.

2. The coupling system of claim 1, wherein said hitch-engaging structures comprise a pair of jaws having proximal end portions pivotably coupled to said frame and distal end portions that are selectively movable away from one another to define the wide hitch-receiving space, and that are selectively movable toward one another to define the narrow hitch-engaging space.

3. The coupling system of claim 2, wherein each of said proximal end portions of said jaws is pivotably coupled to an opposing portion of said frame.

4. The coupling system of claim 2, further comprising a retainer system having:
a retainer link extending upwardly from each of said jaws;
a retainer plate configured to receive upper ends of said retainer links; and
a fastener for securing said retainer plate to said retainer links;
wherein said retainer plate is configured to lie atop a surface of the lower region of the truck camper;
wherein said retainer links pass through an opening formed in the lower region of the truck camper when said jaws are moved toward one another to define the narrow hitch-engaging space; and
wherein said fastener and said retainer plate cooperate to retain said jaws in position to define the narrow hitch-engaging space.

5. The coupling system of claim 4, wherein said fastener comprises a pair of threaded nuts, said retainer links comprise threaded upper end portions configured for engaging said threaded nuts, and said retainer plate defines a pair of holes for receiving respective ones of said retainer links.

6. The coupling system of claim 4, wherein said jaws are biased by gravity to move away from one another and define the wide hitch-receiving space when not acted upon by other forces.

7. The coupling system of claim 2, further comprising a pair of actuating arms having inboard end portions coupled to said jaws, outboard end portions configured for engaging the lower bed panel of the pickup truck, and respective arm pivots for coupling said actuating arms to said frame, each said arm pivot disposed between said inboard end portion and said outboard end portion of each said actuating arm, wherein said outboard end portions cause said inboard end portions to lower and move respective ones of said jaws toward one another in response to said outboard end portions engaging the lower bed panel of the pickup truck as the truck camper is lowered toward the lower bed panel.

8. The coupling system of claim 7, wherein said outboard end portions of said actuating arms comprise counterweights for biasing said inboard end portions of said actuating arms upwardly to move respective ones of said jaws away from one another in response to said outboard end portions disengaging the lower bed panel of the pickup truck as the truck camper is raised away from the lower bed panel.

9. The coupling system of claim 7, wherein said outboard end portions of said actuating arms comprise rollers for engaging the lower bed panel of the pickup truck.

10. The coupling system of claim 1, wherein said hitch-engaging structures comprise a pair of tapered walls forming a retainer ramp, wherein said wide hitch-receiving space comprises a wide mouth opening defined between said tapered walls at an insertion end of said retainer ramp, and said narrow hitch-engaging space comprises a narrow channel defined between said tapered walls at a retaining end of said retainer ramp.

11. The coupling system of claim 10, wherein said tapered walls define a ramped surface having a lower elevation at said wide mouth opening and a higher elevation at said narrow channel, and wherein said retainer ramp is configured to urge the truck camper downwardly as said retainer ramp is moved forwardly along the lower bed panel of the pickup truck while said tapered walls engage the gooseneck hitch structure.

12. A ball hitch coupling system for securing a truck camper in the bed of a pickup truck equipped with a gooseneck hitch structure projecting upwardly from a lower bed panel of the pickup truck, said coupling system comprising:
a frame configured for coupling to a lower region of the truck camper; and
a pair of jaws having respective proximal end portions pivotably coupled to said frame, and respective distal end portions directed toward one another;
wherein said distal end portions of said jaws are pivotably lowerable to a releasing-receiving position below the lower region of the truck camper so that the distal end portions are spaced a first distance apart from one another, and said distal end portions are pivotably raisable to a securing position in which the distal end portions are touching or are spaced a second distance apart from one another that is less than the first distance; and
wherein said distal end portions of said jaws are configured to selectively engage the gooseneck hitch structure in the securing position to selectively secure said coupling system and the truck camper to the gooseneck hitch structure.

13. The coupling system of claim 12, further comprising a retainer system configured for maintaining said jaws in the securing position, wherein said retainer system is accessible from inside the truck camper.

14. The coupling system of claim 13, wherein said retainer system comprises:
a retainer link extending upwardly from each of said jaws;
a retainer plate configured to receive upper ends of said retainer links; and
a fastener for securing said retainer plate to said retainer links;
wherein said retainer plate is configured to lie atop a surface of the lower region of the truck camper;
wherein said retainer links pass through an opening formed in the lower region of the truck camper when said jaws are moved toward one another to the securing position; and
wherein said fastener and said retainer plate cooperate to retain said jaws in the securing position.

15. The coupling system of claim 14, wherein said jaws are biased by gravity toward the releasing-receiving position when not acted upon by other forces.

16. A ball hitch coupling system for securing a truck camper in the bed of a pickup truck equipped with a gooseneck hitch structure projecting upwardly from a lower bed panel of the pickup truck, said coupling system comprising:
a pair of tapered walls forming a retainer ramp that has an insertion end region defining a wide hitch-receiving space, and a retaining end region defining a narrow hitch-engaging channel;
wherein said tapered walls define a ramped surface having a lower elevation at said wide hitch-receiving space and a higher elevation at said narrow hitch-engaging channel; and
wherein said retainer ramp is configured to urge the truck camper downwardly as said retainer ramp is moved forwardly along the lower bed panel of the pickup truck while said tapered walls engage the gooseneck hitch structure.

17. The coupling system of claim 16, wherein said tapered walls cooperate to form a curved V-shape extending from the wide hitch-receiving space to the narrow hitch-engaging channel.

18. The coupling system of claim 16, further comprising:
a pair of rails supporting said retainer ramp, wherein said retainer ramp is longitudinally movable relative to said rails and the truck camper; and
an actuation mechanism operable to drive said retainer ramp along said rails between an unlocking position in which the wide hitch-receiving space receives the gooseneck hitch structure, and a locking position in which the narrow hitch-engaging channel receives the gooseneck hitch structure and said tapered walls engage respective portions of the gooseneck hitch structure to secure the coupling system and the truck camper to the gooseneck hitch structure.

19. The coupling system of claim 18, wherein said actuation mechanism comprises a powered drive.

20. The coupling system of claim 19, wherein said powered drive comprises a drive motor and at least one extendable and retractable cylinder coupled to said retainer ramp.
